(19) United States
(12) Patent Application Publication
(10) Pub. No.: US 2008/0209259 A1
(43) Pub. Date: Aug. 28, 2008

(54) METHOD AND SYSTEM FOR TESTING RELIABILITY OF DATA STORED IN RAID

(75) Inventor: Chih-Wei Chen, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC CORPORATION, Taipei (TW)

(21) Appl. No.: 11/679,619

(22) Filed: Feb. 27, 2007

(51) Int. Cl. G06F 11/08

(52) U.S. Cl. 714/6

(57) ABSTRACT

A system and method for testing reliability of RAID data storage is proposed, which is designed for use with a RAID (Redundant Array of Independent Disks) unit for testing its reliability of data storage operations, and which is characterized by the provision of three testing procedures, namely a redundant data storage testing procedure, a disk reduction procedure and a disk addition procedure. The proposed testing method and system can be used to comprehensively test, for example, the reliability of the mirroring in RAID Level 1 mode.

### FIELD OF THE INVENTION

The present invention relates to redundant array of independent disks (RAID), and more particularly, to a method and system for testing the reliability of data stored in a RAID.

### BACKGROUND OF THE INVENTION

Redundant Array of Independent Disks (RAID) is a data storage device having at least two physical hard disks. In general, the RAID is coupled to a network server via a network, for storing a large amount of data transmitted over the network. Additionally, since the RAID has the physical hard disks, it is often used to improve fault tolerance and backup of data with high reliability.

With respect to fault tolerance and backup of data, the RAID standard defines several data storage modes represented by respective levels. For example, a “RAID Level 0” storage mode indicates that data are alternately stored in two or more physical hard disks; a “RAID Level 1” storage mode indicates that data are mirrored in two or more physical hard disks; a “RAID Level 2” storage mode indicates that data are alternately in two or more physical hard disks in a fault tolerance manner, etc. Basically, RAID storage modes that are commonly used include: RAID Level 0, RAID Level 1, RAID Level 2, RAID Level 3, RAID Level 4, RAID Level 5, RAID Level 6 and RAID Level 10. The abovementioned storage modes, except for RAID Level 0, are all redundant storage technique. However, in the applications of RAID, there still lacks a means for testing the reliability of data stored in RAID.

Detailed information about various levels of RAID storage modes mentioned above can be found in the standards set forth by the RAID Advisory Board, so they will not be further described herein.

### SUMMARY OF THE INVENTION

In the light of forgoing drawbacks, an objective of the present invention is to provide a method and system for testing the reliability of data stored in a RAID, which can be used to test the reliability of data stored in the RAID and the accuracy of the redundant data.

In accordance with the above and other objectives, the method for testing the reliability data stored in a RAID includes: (P1) a redundant data storage testing procedure for testing to see whether the redundant data in the RAID are correct; (P2) a disk reduction testing procedure for simulating a damaged disk member in the RAID while testing the RAID to see if it can still operate normally and data can be read out correctly; and (P3) a disk addition testing procedure for testing whether data can be correctly stored in a disk member newly added to the RAID.

In terms of system architecture, the system for testing reliability of RAID data storage comprising: (A) a data writing unit for writing test data into the RAID; (B) a redundant data testing unit for testing to see whether redundant data stored in the RAID are correct; (C) a RAID operation testing unit for testing to see if the RAID is operating correctly; (D) a RAID rebuilding monitoring unit for monitoring to see if the RAID is carrying out the rebuilding; (E) a disk reduction unit for reducing a designated disk in the RAID; and (F) a disk addition unit for adding a new disk into the RAID.

The method and system for testing the reliability of data stored in a RAID is characterized by the provision of three testing procedures, namely a redundant data storage testing procedure, a disk reduction procedure and a disk addition procedure, thereby the reliability of the RAID data storage can be comprehensively tested.

### BRIEF DESCRIPTION OF THE DRAWINGS

The present invention can be more fully understood by reading the following detailed description of the preferred embodiments, with reference made to the accompanying drawings, wherein:

FIG. 1 is a schematic application diagram depicting an application of the system for testing the reliability of data stored in a RAID of the present invention and its modularized basic structure;

FIG. 2A is a schematic application diagram depicting an example of the system shown in FIG. 1 while executing a test data writing operation;

FIG. 2B is a schematic application diagram depicting an example of the system shown in FIG. 1 of the present invention while executing a redundant data test;

FIG. 2C is a schematic application diagram depicting an example of the system shown in FIG. 1 while executing a rebuilding monitoring operation; and

FIG. 3 is a flowchart illustrating the various testing procedures executed by the system shown in FIG. 1.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

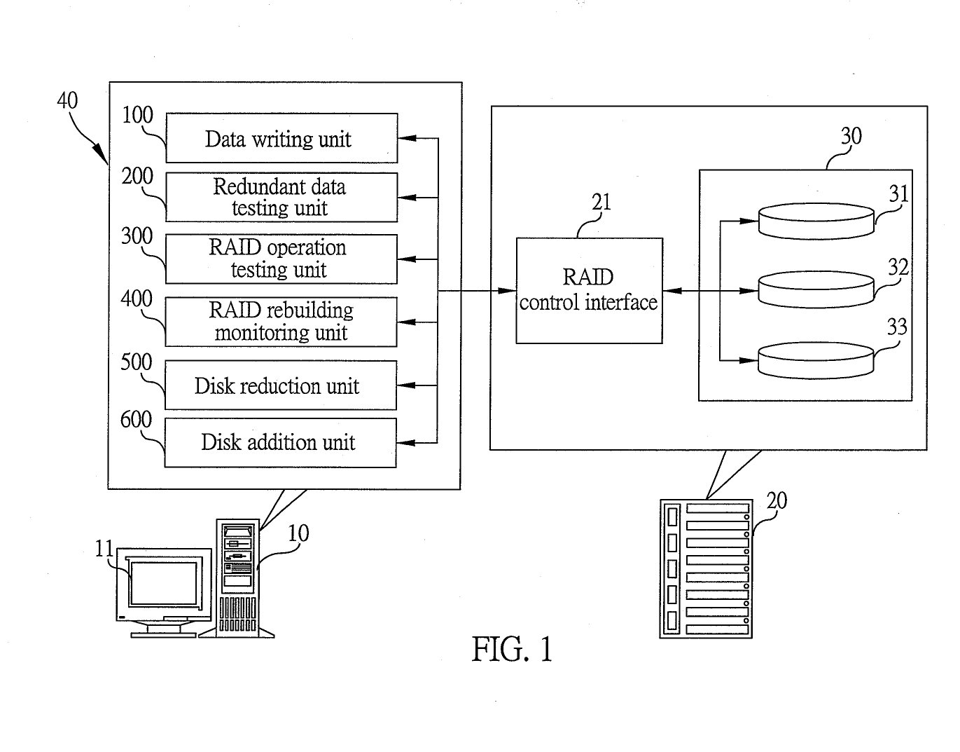

FIG. 1 is an application of a system 40 for testing the reliability of data stored in a RAID 20 of a preferred embodiment according to the present invention. According to this embodiment, the RAID 20 is a Level 1 RAID, and comprises mirrored data. The system 40 can be coupled to a computer such as a network server 10. The network server 10 is provided with the RAID 20. The system 40 performs a data reliability testing procedure on the RAID 20 to test the reliability of a RAID Level 1 data storage capability of the RAID 20.

In the embodiment illustrated by FIG. 1, the RAID 20 comprises a control interface 21, and is illustrated with only three disks 31, 32 and 33 for exemplary purpose. In actual application, the number of disks included in the RAID 20 is not limited to this.

As shown in FIG. 1, the system 40 comprises a data writing unit 100 for writing test data into the RAID 20, a redundant data testing unit 200 for testing whether redundant data stored in the RAID 20 are correct, a RAID operation testing unit 300 for testing whether the RAID 20 is operating normally, a RAID rebuilding monitoring unit 400 for monitoring the RAID 20 and determining whether the RAID 20 is rebuilding, a disk reduction unit 500, and a disk addition unit 600.

The system 40 performs (P1) a redundant data storage testing procedure, (P2) a disk reduction testing procedure, and (P3) a disk addition testing procedure on the Level 1 RAID 20 to test the reliability of date stored in the RAID 20.

### (P1) Redundant Data Storage Testing Procedure

The system 40 performs the redundant data storage testing procedure on the RAID 20 to test whether data stored in the RAID 20 are correct. In other words, the system 40 tests whether the mirrored data are correctly stored in the Level 1 RAID 20. The redundant data storage testing procedure can be further divided into a test data writing sub-procedure and a stored data comparing sub-procedure to determine whether the stored data are correct. These two sub-procedures are implemented by the data writing unit 100 and the redundant data testing unit 200 respectively.

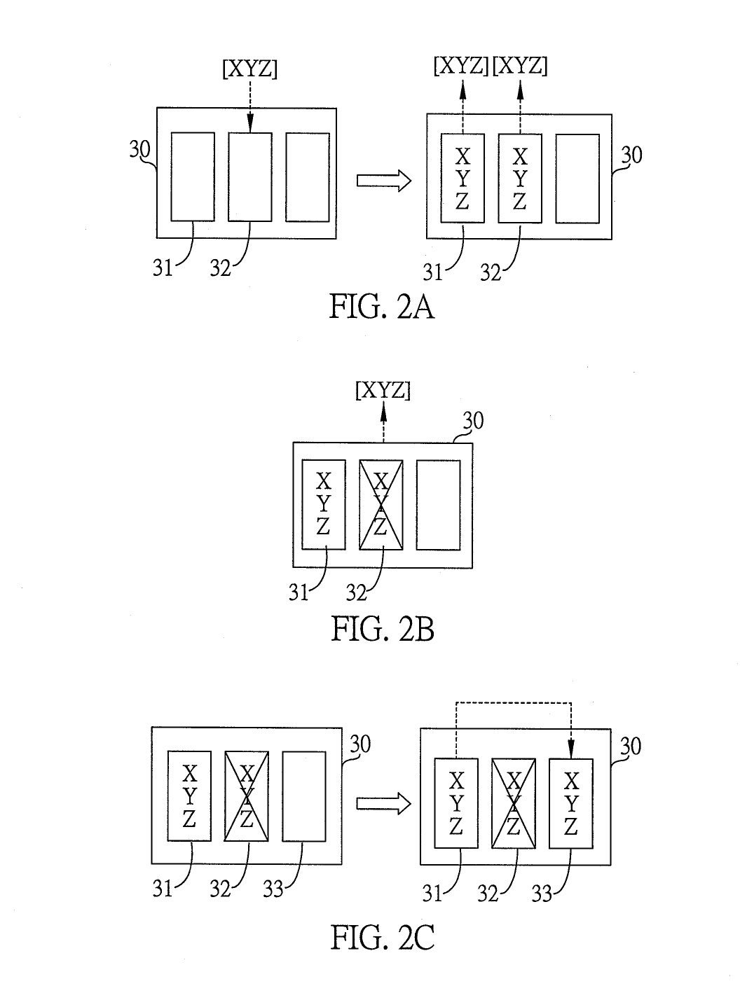

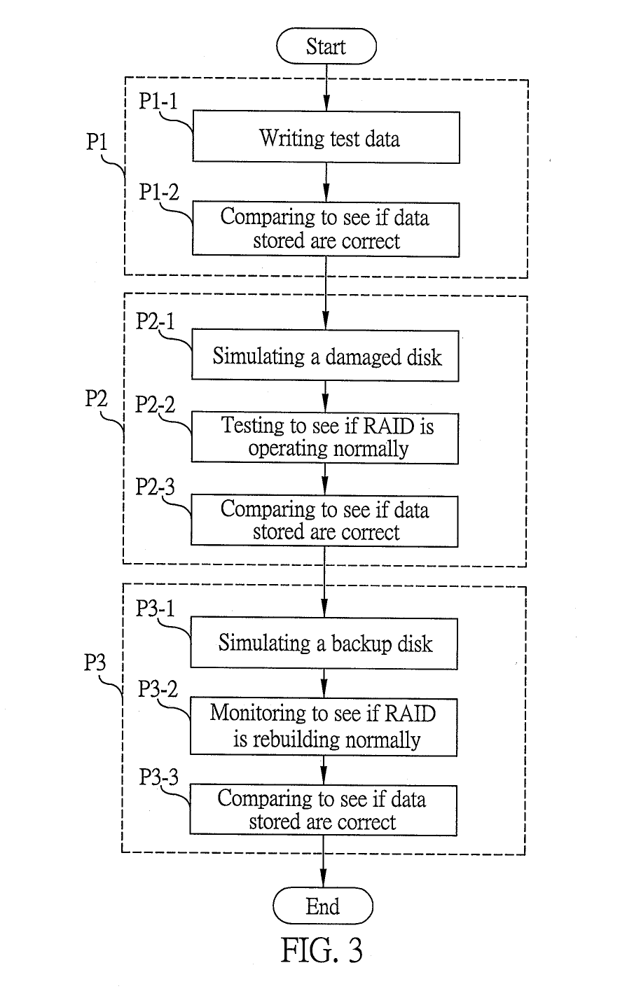

In practice, before the executing of test data writing sub-procedure, three steps can be executed in advance:
(S110) allowing a user (i.e. network system manager) to enter a number of disk members in RAID Level storage mode N, wherein 1<N<Nmax, where Nmax is the maximum number of disk members supported by the RAID 20. In the embodiment shown by FIGS. 2A-2C, the number of disk members is for example two (N=2).
(S111) establishing a RAID Level 1 mirroring disk group 30 via the control interface 21 of the RAID 20. Since N=2, the disk member of the disk group 30 of the RAID 20 includes a first disk 31 and a second disk 32 (a third disk 33 functions as a backup disk), as shown in FIG. 2A.
(S112) reading the total number of blocks B in the disk group 30.

The operation of writing test data (P1-1) includes writing a set of original test data (for example, indicted by [XYZ]) into each disk member (including the first disk 31 and the second disk 32) of the disk group 30 according to the rules of RAID Level 1 as shown in FIG. 2A. In actual implementations, the exemplary detailed steps of this operation are as follow:
(S121) Execute a block configuring write process on the first disk 31 and the second disk 32 until the storage space is full.
(S122) Stop the RAID 20 via the control interface 21.

The operation of comparing stored data to see if it is correct (P1-2) includes comparing the data stored in the first disk 31 and the second disk 32 of the disk group 30 by the above data writing unit 100 with the original test data [XYZ], so as to determine whether each disk member 31 and 32 of the disk group 30 is able to store data correctly. In actual implementations, the exemplary detailed steps of this operation are as follow:
(S131) reading out the data stored in the first disk 31 of the disk group 30 and compare it with the original test data [XYZ] in order to determine if a fault has occurred; if so, then send out a read-action error message, for example, to be displayed on a monitor 11 of the network server 10 for informing the user.
(S132) comparing the data stored in the first disk 31 with other disk members (i.e. the second disk 32) in order to determine if a fault has occurred in the latter; if so, then send out a comparison error message, for example, to be displayed on the monitor 11 of the network server 10 for informing the user.
(S133) reactivating the RAID 20 via the RAID control interface 21.
(S134) executing a data read operation on the RAID 20 and compare it with the original test data [XYZ] in order to determine if a fault has occurred; if so, then send out a read-action error message, for example, to be displayed on the monitor 11 of the network server 10 for informing the user.
   (P2) Disk reduction Testing Procedure

The disk reduction testing procedure P2 is used to simulate a situation when one of the disk members in the RAID 20 is damaged, so as to see if it can still operate correctly and data can be read out correctly.

In this embodiment, the procedure is used to test whether the RAID 20 in RAID Level 1 can still operate normally and data can be read out correctly in the case of a disk member of the disk group 30 being damaged (or removed). FIG. 2B illustrates an example simulating a situation when the second disk 32 is damaged while the first disk 31 is fine.

The disk reduction testing procedure P2 can be further divided into three operations, including: (P2-1) simulating a damaged disk; (P2-2) testing to see if the RAID still operates normally and (P2-3) comparing the stored data with the original data to see if it is correct. These operations are carried by the disk reduction unit 500, the RAID operation testing unit 300 and the redundant data testing unit 200, respectively.

The operation of simulating a damaged disk (P2-1) includes simulating any one disk member of the disk group 30 (the second disk 32 in this embodiment) as a damaged disk, so as to see if the RAID 20 can still operate normally and the stored previously stored can be read out therefrom correctly in the case of having a damaged disk member.

Since the RAID 20 is a RAID Level disk array, it can tolerate the reduction of one disk. However, when the number of reduction is greater than two, the operations of (P2-1), (P2-2) and (P2-3) can be continued until the number of undamaged disk member becomes one.

In actual implementation, the detailed steps of this operation are as follow:
(S211) Stop the RAID 20 via the RAID control interface 21.
(S212) Randomly select a disk member from the mirroring disk group 30 (e.g. the second disk 32), and clear its configuration information (RAID superblock).

This action removes the second disk 32 from the disk members, and therefore simulates the second disk 32 as a damaged disk.

The operation of testing to see if the RAID still operates normally (P2-2) is used to test if the RAID 20 can operate correctly. In actual implementation, the detailed steps of this operation are as follow:
(S221) Restart the operation of the RAID 20 via the RAID control interface 21.
(S222) Check if the RAID 20 can still operate normally under the circumstance of the second disk 32 in the disk members being simulated as a damaged disk; if the operation fails, then send out an operation failed message, for example, to be displayed on the monitor 11 of the network server 10 for informing the user.

The operation of comparing the stored data with the original data to see if it is correct (P2-3) includes comparing the mirrored data read out by a data comparison module with the original test data [XYZ] in order to check if the RAID 20 can still provide data correctly. In actual implementation, the detailed step of this operation is as follows:
(S231) Read out the stored data and compare it with the original test data [XYZ] to see if a fault has occurred; if so, then send out a redundant data failed message, for example, to be displayed on the monitor 11 of the network server 10 for informing the user.

### (P3) Disk Addition Testing Procedure

The disk addition testing procedure P3 in this embodiment is used to test the RAID 20 in RAID Level 1 to see if another disk (e.g. the third disk 33) can be successfully rebuilt and correctly store the data in the case of any one disk member (e.g. the second disk 32) in the disk group 30 fails. This rebuilding testing procedure can be further divided into three operations, including: (P3-1) simulating a backup disk; (P3-2) monitoring to see if the RAID is rebuilding normally and (P3-3) comparing to see if the stored data are correct. These operations are carried out by the disk addition unit 600, the RAID rebuilding monitoring unit 400 and the redundant data testing unit 200, respectively.

The operation of simulating a backup disk (P3-1) includes selecting a non-member disk (e.g. the third disk 33) from the mirroring disk group 30 and designating it as a backup disk. In actual implementation, the detailed steps of this operation are as follow:
(S311) Stop the RAID 20 via the RAID control interface 21.
(S312) Randomly select a non-member disk (e.g. the third disk 33 shown in FIG. 2C) in the RAID 20, and modify the selected disk (i.e. the third disk 33) in a way such that it has the same configuration (i.e. the configuration data stored in RAID superblock) as the rest of the disk members (i.e. the first disk 31), thereby setting the third disk 33 as a disk member.

It should be noted here that in the disk reduction testing procedure P2, after the second disk 32 is removed from the disk members, the second disk 32 then becomes a non-member disk, so in the disk addition testing procedure P3, the second disk 32 can be added back again as a new disk member.

The operation of monitoring to see if the RAID is rebuilding normally (P3-2) includes, in the case of a disk member being damaged in the mirroring disk group 30, after the RAID 20 is reactivated, automatically monitoring to see if the RAID 20 is carrying out the rebuilding process by adding a new disk member. In actual implementation, the detailed steps of this operation are as follow:
(S321) Restart the operation of the RAID 20 via the RAID control interface 21.
(S322) Monitor the RAID 20 via the RAID control interface 21 to see if it is in a rebuilding mode; if not, then send out a rebuilding function failed message, for example, to be displayed on the monitor 11 of the network server 10 for informing the user.
(S323) Continuously monitor the RAID 20 until the rebuilding process has completed.

The operation of comparing to see if the stored data are correct (P3-3) includes, after the above rebuilding process is completed, comparing the data rebuilt in the newly added disk member (i.e. the third disk 33) with the original data [XYZ], so as to check whether the RAID 20 can reliably execute the rebuilding process and correctly establish redundant data. In actual implementation, the detailed steps of this operation are as follow:
(S331) Read out the data rebuilt in the third disk 33 and compare it with the original data [XYZ]; if there is a fault, then send out a rebuilding failed message, for example, to be displayed on the monitor 11 of the network server 10 for informing the user.
(S332) Stop the RAID 20 via the RAID control interface 21.

Similarly, if the number of disk members is greater than two, then the operations of (P3-1), (P3-2) and (P3-3) can be repeated until the number of disk members reaches the initial setup value.

Having completed the above three testing procedures, the data storage reliability of the RAID 20 in RAID Level 1 mode can be comprehensively tested.

In conclusion, the RAID data storage reliability testing method and system of the present invention is characterized by the provision of the redundant data storage testing procedure, the disk reduction testing procedure and the disk addition testing procedure, thereby automatically testing the reliability of the RAID data storage under various circumstances. The present invention thus has inventiveness and industrial applicability.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A method for testing reliability of data stored in a Redundant Array of Independent Disks (RAID), the method comprising:
a redundant data storage testing procedure testing the RAID to determine whether redundant data stored in the RAID are correct;
a disk reduction testing procedure simulating a damaged disk member in the RAID while testing the RAID to see if the partially damaged RAID can still operate normally and data can be read out correctly; and
a disk addition testing procedure testing the RAID after added with a new disk to determine whether data can be correctly stored in the newly added disk.

2. The method of claim 1, wherein the redundant data storage testing procedure comprising:
writing test data into the RAID; and
comparing the test data before written into the RAID and the test data after written and stored into the RAID to determine whether the test data stored in the RAID are correct.

3. The method claim 2, wherein the disk reduction testing procedure comprising:
simulating a damaged disk;
testing to see if the RAID is operating normally; and
comparing to see if the data stored are correct.

4. The method for testing reliability of RAID data storage of claim 1, wherein the disk addition testing procedure is used, in the case of a disk member in the RAID being damaged, to test if another disk is capable of normally executing a rebuilding process, and the rebuilding process comprising:
simulating a backup disk;
monitoring to see if the RAID is rebuilding normally; and
comparing to see if the data stored are correct.

5. A system for testing reliability of data stored in a RAID, the system comprising:
a data writing unit for writing test data into the RAID;
a redundant data testing unit for testing to see whether redundant data stored in the RAID are correct;
a RAID operation testing unit for testing to see if the RAID is operating correctly;
a RAID rebuilding monitoring unit for monitoring to see if the RAID is carrying out the rebuilding;
a disk reduction unit for reducing a designated disk in the RAID; and
a disk addition unit for adding a new disk into the RAID.

6. The system claim 5, wherein the computer platform is a network server.

7. The system claim 5, wherein the data writing unit and the redundant data testing unit cooperatively execute a redundant data storage testing procedure, which comprising:
a test data write step for writing a set of test data into the RAID; and
a comparison step for comparing to see if the data stored are correct.

8. The system claim 5, wherein the redundant data testing unit, the RAID operation testing unit, the disk reduction unit and the disk addition unit cooperatively execute a disk reduction testing procedure, comprising:
simulating a damaged disk;
testing to see if the RAID is operating normally; and
comparing to see if the data stored are correct.

9. The system claim 5, wherein the disk addition unit, the RAID rebuilding monitoring unit and the redundant data testing unit cooperatively execute a disk addition testing procedure, and the disk addition testing procedure being used, in the case of a disk member in the RAID being damaged, to test if another disk is capable of normally executing a rebuilding process, wherein the rebuilding process comprising:
simulating a backup disk;
monitoring to see if the RAID is rebuilding normally; and
comparing to see if the data stored are correct.
